(19) United States
(12) Patent Application Publication
(10) Pub. No.: US 2024/0303653 A1
(43) Pub. Date: Sep. 12, 2024

(54) SYSTEMS AND METHODS FOR IMPLEMENTING BLOCKCHAIN-BASED PLATFORMS FOR ONLINE SKILL-BASED COMPETITIONS

(71) Applicant: Moxy.io, Inc., Seattle, WA (US)

(72) Inventors: Derek RATHBUN, Trabuco Canyon, CA (US); Matthew DeFOUW, Kamloops (CA); Lawrence David SIEGEL, Seattle, WA (US); Stewart Douglas BELL, Gloucestershire (GB)

(21) Appl. No.: 18/485,943

(22) Filed: Oct. 12, 2023

Related U.S. Application Data
(60) Provisional application No. 63/488,593, filed on Mar. 6, 2023.

(51) Int. Cl. G06Q 20/40; G06Q 20/36; G06Q 20/38

(52) U.S. Cl. CPC G06Q 20/401; G06Q 20/36; G06Q 20/389

(57) ABSTRACT

A cryptocurrency platform that facilitates wagering of cryptocurrency natively within an online skills based competition (e.g., a video game) hosted, sold and/or distributed by a third party game platform. The cryptocurrency platform may facilitate distribution of wagered cryptocurrency between competition participants (and/or spectators) based at least in part on one or more results of the online skills based competition. In some embodiments, a portion of the distributed wagered cryptocurrency is distributed to the third party game platform (e.g., as a hosting fee or cut of the wagers), and/or the cryptocurrency platform (e.g., as a service fee).

### RELATED APPLICATIONS

This application claims priority from (and the benefit under 35 USC § 119 of) US Patent Application No. 63/488,593 filed 6 Mar. 2023 which is hereby incorporated herein by reference.

### TECHNICAL FIELD

Cryptocurrency transaction systems for online skill-based competitions; particularly cryptocurrency transaction systems enabling third party online skill-based competition hosts to use cryptocurrency transactions for event fees, wagers and/or rewards.

### BACKGROUND

Online skills-based competitions, such as electronic sports (also called “esports”), enable players to compete against each other in organized competitions. These organized competitions increasingly involve fees, wagers and/or rewards using either (or both) in-game currencies and out-of-game currencies.

Out-of-game currencies may include cryptocurrencies, i.e., digital currencies implemented through distributed ledger technology (also commonly referred to as blockchain technology). There is a general desire among hosts of online skills-based competition to use cryptocurrencies in place of, or in addition to, in-game currencies for such competition elements as event fees, wagers, and/or event rewards. However, the software needed to utilize cryptocurrencies in this way can be technically complex and beyond the capacity of a traditional online skills-based competition host, such as a video game platform, to develop and/or operate in-house without an undesirable investment of resources.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for facilitating wagering of cryptocurrency registered on a blockchain or distributed ledger between participants in an online skills-based competition hosted by a third party, each participant having a cryptocurrency wallet registered on the blockchain or distributed ledger. The method comprises for each participant, receiving an authorization request from the third party for a wager of the cryptocurrency, determining if the authorization request should be accepted based at least in part on a balance in the cryptocurrency wallet of the participant and, if accepted, transferring a first quantity of cryptocurrency from the cryptocurrency wallet of the cryptocurrency holder to a custodial wallet based at least in part on the wager, receiving from the third party a report of one or more measurable outcomes from the online skill-based competition, preparing a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition, registering the smart contract on the blockchain ledger and executing the smart contract to thereby distribute the at least a portion of cryptocurrency in the custodial wallet to the respective cryptocurrency wallets of the one or more of the participants based at least in part on the report of the one or more measurable outcomes.

In some embodiments, the first smart contract is produced dynamically based in part on the report of the one or more measurable outcomes from the online skills-based competition.

In some embodiments, the balance in the cryptocurrency wallet of the participant is a balance of pre-authorized cryptocurrency in the wallet of the participant. In some embodiments, the pre-authorized cryptocurrency is pre-authorized by the participant for use in wagering or competition fees for the online skills-based competition hosted by the third party. In some embodiments, the pre-authorized cryptocurrency represents only a portion of a total balance in the cryptocurrency wallet of the participant. In some embodiments, transferring the first quantity of cryptocurrency from the cryptocurrency wallet of the cryptocurrency holder to the custodial wallet based at least in part on the wager is carried out on behalf of the participant since the pre-authorized cryptocurrency is pre-authorized by the participant for use in wagering or competition fees for the online skills-based competition hosted by the third party.

In some embodiments, preparing the smart contract occurs prior to transferring the first quantity of cryptocurrency from the cryptocurrency wallet of the cryptocurrency holder to the custodial wallet based at least in part on the wager and transferring the first quantity of cryptocurrency from the cryptocurrency wallet of the cryptocurrency holder to the custodial wallet based at least in part on the wager comprises executing a first stage of the smart contract. In some embodiments, preparing the smart contract occurs prior to receiving the authorization request from the third party for the wager of the cryptocurrency for each participant.

In some embodiments, the method comprises returning the first quantity of cryptocurrency to the cryptocurrency wallets of the participants in the event of a parameter failure or the non-receipt of the report of the one or more measurable outcomes within a pre-defined period of time. In some embodiments, the method comprises executing a fault-response smart contract, the fault-response smart contract performing the returning of the first quantity of cryptocurrency to the cryptocurrency wallets of the participants in the event of a parameter failure or the non-receipt of the report of the one or more measurable outcomes within a pre-defined period of time. In some embodiments, returning the first quantity of cryptocurrency to the cryptocurrency wallets of the participants is performed by the first smart contract.

In some embodiments, the first quantity of cryptocurrency comprises entry fees and the one or more measurable outcomes comprises a scoring list for a set of players in the online skills-based competition.

In some embodiments, the one or more of the cryptocurrency holders are players in the online skills-based competition. In some embodiments, the one or more participants are spectators of the online skills-based competition.

In some embodiments, for a first participant of the participants, the authorization request from the third party for the wager of the cryptocurrency is received in response to the first participant scanning, with a mobile device of the first participant, a barcode displayed by the third party on a first display and inputting account information into a form displayed on the mobile device in response to scanning the barcode. In some embodiments, the barcode is a QR code. In some embodiments, the account information comprises account information for the third party. In some embodiments, the account information comprises account information for the cryptocurrency wallet of the participant.

In some embodiments, the wager is the same for each participant. In some embodiments, the wager for each participant is based on a skill level, ranking and/or handicap of each participant.

Another aspect of the invention provides a method of distributing cryptocurrency between spectators of a video game event. The method comprises transferring a first quantity of cryptocurrency from the first cryptocurrency wallet of each of a plurality of cryptocurrency holders participating in the video game event to a custodial wallet, receiving a report of one or more measurable outcomes from the video game event, and deploying a first smart contract to distribute a portion of cryptocurrency in the custodial wallet to one or more of the cryptocurrency holders, wherein the distribution of the portion of cryptocurrency is based in part on the report of the one or more measurable outcomes from the video game event.

Another aspect of the invention provides a method of distributing cryptocurrency between cryptocurrency holders involved in a video game event, each cryptocurrency holder having a first cryptocurrency wallet. The method comprises transferring a first quantity of cryptocurrency from the first cryptocurrency wallet of each cryptocurrency holder participating in the video game event to a custodial wallet, receiving a report of one or more measurable outcomes from the video game event and distributing a portion of the first quantity of cryptocurrency in the custodial wallet to one or more of the cryptocurrency holders based on the report of the one or more measurable outcomes from the video game event.

Another aspect of the invention provides a method of distributing cryptocurrency registered on a first blockchain ledger between cryptocurrency holders, each cryptocurrency holder involved in an online skill-based competition hosted by a third party, each cryptocurrency holder having a first cryptocurrency wallet registered on the first blockchain ledger. The method comprises for each cryptocurrency holder: receiving a authorization request from the third party for a wager of a first quantity of cryptocurrency, determining if the authorization request should be accepted based at least in part on a balance in the first cryptocurrency wallet of the cryptocurrency holder and, if accepted, transferring a first quantity of cryptocurrency from the first cryptocurrency wallet of the cryptocurrency holder to a custodial wallet, receiving from the third party a report of one or more measurable outcomes from the online skill-based competition, preparing a first smart contract to distribute a portion of cryptocurrency in the custodial wallet to one or more of the cryptocurrency holders, wherein the distribution of the portion of cryptocurrency is based at least in part on the report of the one or more measurable outcomes from the online skill-based competition, registering the first smart contract on the first blockchain ledger and executing the first smart contract to thereby distribute a portion of cryptocurrency in the custodial wallet to the respective first cryptocurrency wallets of the one or more of the cryptocurrency holders based at least in part on the report of the one or more measurable outcomes.

Another aspect of the invention provides a method of distributing cryptocurrency registered on a first blockchain ledger between cryptocurrency holders, each cryptocurrency holder involved in an online skill-based competition hosted by a third party, each cryptocurrency holder having a first cryptocurrency wallet registered on the first blockchain ledger. The method comprises registering a first smart contract on the first blockchain ledger, executing a first stage of the first smart contract to transferring a first quantity of cryptocurrency from the first cryptocurrency wallet of each cryptocurrency holder participating in the online skill-based competition to a custodial wallet, executing a second stage of the first smart contract to distribute a first portion of the first quantity of cryptocurrency in the custodial wallet to one or more of the cryptocurrency holders based on one or more measurable outcomes from the online skills-based competition.

Another aspect of the invention provides a system for facilitating wagering of cryptocurrency registered on a blockchain or distributed ledger between participants in an online skills-based competition hosted by a third party, each participant having a cryptocurrency wallet registered on the blockchain or distributed ledger. The system is configured to, for each participant, receive an authorization request from the third party for a wager of the cryptocurrency, determine if the authorization request should be accepted based at least in part on a balance in the cryptocurrency wallet of the participant and, if accepted, transfer a first quantity of cryptocurrency from the cryptocurrency wallet of the cryptocurrency holder to a custodial wallet based at least in part on the wager, receive from the third party a report of one or more measurable outcomes from the online skill-based competition, prepare a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition, register the smart contract on the blockchain ledger and execute the smart contract to thereby distribute the at least a portion of cryptocurrency in the custodial wallet to the respective cryptocurrency wallets of the one or more of the participants

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flow chart illustrating a process by which a cryptocurrency platform can facilitate the wagering of cryptocurrency in a third party online competition platform according to an exemplary embodiment of the invention.

FIG. 2 is a block illustration of the parties involved in at least a portion of a process by which a cryptocurrency platform can facilitate the wagering of cryptocurrency in a third party online competition platform according to an exemplary embodiment of the invention.

FIG. 3 is another block illustration of the parties involved in at least a portion of a process by which a cryptocurrency platform can facilitate the wagering of cryptocurrency in a third party online competition platform according to an exemplary embodiment of the invention.

FIG. 4 is a flow chart illustrating a sub-process of the process of FIG. 1 for determining whether to accept an authorization request for cryptocurrency funds.

FIG. 5 is a flow chart illustrating another process by which a cryptocurrency platform can facilitate the wagering of cryptocurrency in a third party online competition platform according to an exemplary embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a cryptocurrency platform that facilitates wagering of cryptocurrency natively within an online skills based competition (e.g., a video game) hosted, sold and/or distributed by a third party game platform. The cryptocurrency platform may facilitate distribution of wagered cryptocurrency between competition participants (and/or spectators) based at least in part on one or more results of the online skills based competition. In some embodiments, a portion of the distributed wagered cryptocurrency is distributed to the third party game platform (e.g., as a hosting fee or cut of the wagers), and/or the cryptocurrency platform (e.g., as a service fee). The cryptocurrency platform maintains the cryptocurrency using a distributed ledger. Each participant is the owner and/or controller of at least one cryptocurrency wallet that is registered on the distributed ledger. The online skill-based competition may comprise, for example, a video game competition. The systems and processes provided by the cryptocurrency platform enable third party game platforms to utilize cryptocurrency for competition fees, wagering and/or rewards without requiring the third party game platforms to directly process blockchain distributed ledger transactions, maintain its own cryptocurrency and/or invest resources in cryptocurrency technology. Further, where multiple third party game platforms use the same cryptocurrency platform, users can wager the same cryptocurrency across each of the third party game platforms without creating new cryptocurrency accounts and/or wallets for each third party game platform, without purchasing or exchanging multiple different cryptocurrencies, etc.

Throughout this text, references are made to communications between one or more participants and a third party game platform. Interactions and communications between the participant and the third party game platform may take the form of interface interactions, i.e., interactions in a user interface of a program in which the participant's actions in the interface cause communications between a participant's machine (e.g., a personal computer, a gaming device, a gaming console, a mobile device, etc.) and one or more servers hosting the third party game platform. References are also made to communications between the third party game platform and the cryptocurrency platform (which may be hosted by one or more servers and/or one or more blockchain nodes). These communications may take various forms known to software developers and programmers. These communications may be enabled, for example, as an interface between two computer programs in the form of an application programming interface (commonly referred to as an “API”).

There are also communications and interactions between the cryptocurrency platform and the blockchain. The blockchain may variously be referred to as the distributed ledger, the distributed network or the blockchain network. In the blockchain network, there are a plurality of nodes that make up and/or host the network. Communications between the cryptocurrency platform and the blockchain may be enabled, for example, through a software development kit (commonly referred to as an “SDK”). Other methods may also be used to enable communications between the cryptocurrency platform and the blockchain network maintained by the cryptocurrency platform. For example, a cryptocurrency platform may use an API to interact with nodes on the blockchain network.

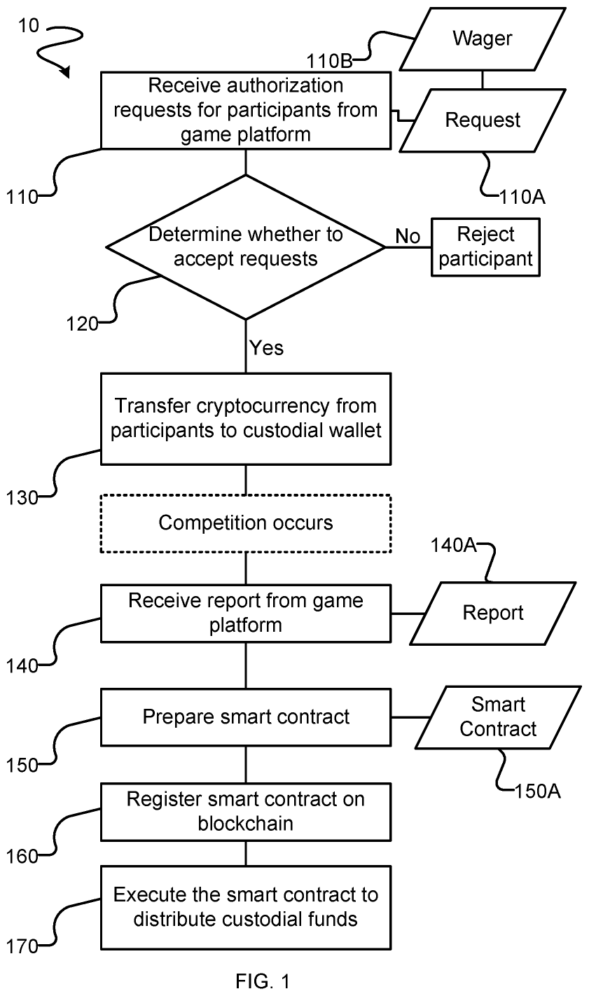

FIG. 1 is a flowchart illustrating a process 10 by which a cryptocurrency platform 25 facilitates wagering and distribution of a cryptocurrency 29 in association with an online skill-based competition 15 (also referred to herein as competition 15). At least a portion of the wagered cryptocurrency may be distributed between participants 20 of competition 15 based at least in part on one or more results of online skill-based competition 15. In some embodiments, a portion of the wagered cryptocurrency is distributed to the third party game platform 30 (also referred to as game platform 30) hosting the online skill-based competition 15, and/or the cryptocurrency platform 25 itself. Participants 20 may comprise players in online skill-based competition 15. Participants 20 may comprise other parties that are not partaking in online skill-based competition 15 but are merely wagering on the results of competition 15 and/or the occurrence of one or more events within competition 15.

It should be understood that process 10 may employ any cryptocurrency recorded on any distributed ledger or blockchain. In some embodiments, process 10 occurs with only a single cryptocurrency 29 recorded on a single blockchain 27 thereby simplifying transactions that occur during process 10. However, it should be understood that process 10 could occur with multiple exchangeable cryptocurrencies (e.g., by choosing a base cryptocurrency for transacting throughout process 10 and converting any other accepted cryptocurrencies to the base cryptocurrency as needed based on agreed upon exchange rates). For simplicity, process 10 is described in relation to a single cryptocurrency 29 recorded on a single distributed ledger or blockchain 27.

For the purpose of process 10, it is assumed that each participant 20 has an account (or other identifier) registered with game platform 30 and an account (or other identifier) registered with cryptocurrency platform 25. The account of a participant 20 with cryptocurrency platform 25 may be, for example, in the form of a wallet 35 registered with or linked to blockchain 27 cryptocurrency platform 25. If at the start of process 10, it is determined that a potential participant 20 does not have an account with game platform 30, then the potential participant 20 may be prompted to create an account with game platform 30. Likewise, if it is determined that a potential participant 20 does not have an account with cryptocurrency platform 25 prior to the start of process 10 or during process 10 (e.g., at block 120), the potential participant may be prompted to create an account with cryptocurrency platform 25 (and obtain cryptocurrency funds). If the potential participant does not create the account, then process 10 may end for that potential participant.

The association or linking of a game platform 30 account of a particular participant with an account registered with cryptocurrency platform 25 of that participant may be used to coordinate requests 110A and reports 140A (discussed further herein). In some circumstances, a cryptocurrency platform 25 account and a game platform 30 account might be merged. For example, game platform 25 may accept credentials of a cryptocurrency platform 30 account (or vice versa).

Each participant 20 is the owner and/or controller of at least one cryptocurrency wallet 35 that is registered on blockchain 29 associated with cryptocurrency platform 25. Wallet 35 contains cryptocurrency funds 37.

In some embodiments, each participant 20 can pre-authorize a subset of funds 37 within their wallet 35 as pre-authorized funds 37A for wagering or payment of event fees for one or more game platforms 30. Such a pre-authorization may specify, for example, which game platforms 30 are pre-authorized, how much can be wagered with each (or any) game platform 30 in total or at a time, what quantity of total funds 37 in wallet 35 is pre-authorized, etc. In some embodiments, participant 20 may agree to pre-authorize a first amount and agree that when only a specified portion of the first amount is left, a second amount is automatically pre-authorized and this may continue until participant 20 has insufficient funds or retracts their pre-authorization. Pre-authorized funds 37A may be available to fulfil requests 110A (discussed further herein). In some embodiments, a participant 20 can pre-authorize less than the entire quantity of funds 37 within their wallet 35 such that pre-authorized funds 37A comprises only a subset of funds 37 of wallet 35. In some embodiments, a participant 20 pre-authorizes wallet 35 such that an entirety of funds 37 of wallet 35 are pre-authorized funds 37A flagged as being pre-authorized to be available to fulfil requests 110A. In either case, participant 20 may maintain a second wallet with additional funds where such additional funds may not be pre-authorized to be available for requests 110A.

Pre-authorization may comprise participant 20 pre-signing for specific types of transactions to occur from wallet 35 or otherwise authorizing cryptocurrency platform 25 to perform specific types of transactions on behalf of participant 20 out of pre-authorized funds 37A. Pre-authorization may include participant 20 providing a private key associated with the pre-authorized funds 37A to cryptocurrency platform 25. These pre-authorization steps may signal to cryptocurrency platform 25 that further authorization is not required from participant 20 to implement specified transfers of pre-authorized funds 37A to other cryptocurrency wallets (e.g., at block 130 of process 10, as discussed further herein).

The separation of pre-authorized funds 37A in wallet 35 from remaining funds 37 in wallet 35 (or a second wallet of participant 20) may assist with maintaining security of the balance of funds 37 of participant 20 while assisting in the efficient wagering of pre-authorized funds 37A. For example, such pre-authorization may allow cryptocurrency platform 25 to perform transactions (e.g., at block 130 of process 10) on behalf of participant 20 without participant 20 leaving an ecosystem of game platform 30 during process 10. In this way, process 10 may provide a seamless experience to participant 20. Process 10 may provide such seamless experience without requiring game platform 30 to invest significant resources in implementing process 10.

Referring to FIG. 1, at block 110 cryptocurrency platform 25 receives an authorization request 110A for a wager 110B from game platform 30 on behalf of a first participant 20-1. Authorization request 110A may ask cryptocurrency platform 25 to determine if first participant 20-1 has sufficient pre-authorized funds 37A in their wallet 35 to satisfy wager 110B of authorization request 110A. Request 110A may be caused to be sent to cryptocurrency platform 25 through an interaction of participant 20-1 with game platform 30. For example, request 110A may be initialized by first participant 20-1 clicking a “wager now” button or “enter game” button within game platform 30. Request 110A may then be transferred from the game platform 30 to cryptocurrency platform 25 by any suitable means.

Block 110 may comprise receiving authorization request 110A for each participant 20 that wants to participate in competition 15. For example, at block 110 a second participant 20-2 may cause a second authorization request 110A to be sent to cryptocurrency platform 25 to determine if second participant 20-2 has sufficient pre-authorized funds 37A in their wallet 35 to satisfy wager 110B.

Wager 110B of second participant 20-2 (and further participants 20) may be equal in magnitude to wager 110B of first participant 20-1 but this is not mandatory and may depend on the rules of the online skill-based competition 15. In some embodiments, wager 110B for each participant may be dependent on a ranking, skill level and/or handicap of that participant 20. For example, higher ranked participants 20 may be asked to wager larger amounts while lower ranked participants 20 may be asked to wager lesser amounts so as to entice lower ranked participants 20 to participate in online skill-based competition 15 despite their lack of ranking or lack of skill. The ranking, skill level and/or handicap of a participant 20 may be determined based on previous playing of that participant 20 within game platform 30 (and/or other game platforms). Where a participant 20 has no previous history in gaming platform 30 (or is very lowly ranked), they may be asked to wager 110B a minimum amount (which could even be zero).

In some embodiments, wager 110B for one or more participants 20 may be zero (whether their ranking, skill level and/or handicap is low or high). This may occur, for example, where a third party (e.g., a sponsor of gaming platform 30 or a sponsor of such one or more participants 20) pays on behalf of such one or more participants 20. In some embodiments, competition 15 is entirely sponsored such that wager 110B is zero for all participants 20.

Authorization requests 110A for different participants 20 may be received at the same time or at different times such that block 110 may occur at a first time for a first participant 20-1 and at a second time for a second participant 20-2. In some embodiments, process 10 does not proceed to block 120 and/or block 130 until all requests 110A are received at block 110 but this is not mandatory. The number of requests 110A may depend on the rules of competition 15. In some embodiments, process 10 may continue to blocks 120 and/or 130 for one or more participants 20 before requests 110A are received for all participants 20. In this way, blocks 110, 120 and 130 may occur at least in part, in parallel and/or in series for various participants 20.

In some embodiments, such as where a participant 20 (e.g., first-participant 20-1) is accessing game platform 30 through a new device (e.g., a gaming console, computer, mobile device or the like into which first participant 20-1 has not previously inputted their cryptocurrency platform 25 account information and/or game platform 30 account information) or an unsecure device (e.g., a gaming console, computer, mobile device or the like that is accessible to third parties and which may therefore be more susceptible to security breaches), it may be desirable for first participant 20-1 to start method 10 without having to input their cryptocurrency platform 25 account information and/or game platform 30 account information directly into the device. This may be accomplished, for example, as follows.

First participant 20-1 may access game platform 30 via the new/unsecure device and choose an online skill-based competition 15 that they wish to enter (all without logging into game platform 30 or cryptocurrency platform 25 on the new/unsecure device—i.e., without inputting account information for either of game platform 30 or cryptocurrency platform 25 into the new/unsecure device). Once first participant 20-1 has chosen an online skill-based competition 15 to enter, a barcode (e.g., a QR code) and/or a web link may be displayed by game platform 30 on the new/unsecure device.

First participant 20-1 may scan the barcode (e.g., QR code) displayed by game platform 30 with a camera of a mobile device of the participant 20-1. Scanning the barcode may occur using a mobile application of cryptocurrency platform 25 that has access to the camera of the mobile device or a mobile application of gaming platform 30 that has access to the camera of the mobile device. Scanning the barcode may occur with a native camera mobile application of the mobile device which may cause a mobile application of gaming platform 30 or cryptocurrency platform 25 to open on the mobile device.

Alternatively, first participant 20-1 may input the web link into a web browser mobile application of their mobile device which may take them to a web page which may cause (or allow) a web page or mobile application of gaming platform 30 or cryptocurrency platform 25 to open on the mobile device. In some embodiments, the web page may first prompt the user to input a code that is also displayed by game platform 30 for increased security.

First participant 20-1 may then be prompted on their mobile device with a form to login to platform 25 and/or gaming platform 30 (or they may have already logged in previously). As the accounts of first participant 20-1 for cryptocurrency platform 25 and gaming platform 30 are linked, as discussed further herein, once first participant 20-1 is logged in to the web page or mobile application of either of cryptocurrency platform 25 or gaming platform 30, cryptocurrency platform 25 may receive the request 110A associated with the barcode (or web link) thereby causing block 120 to occur as discussed herein. If a yes determination is then made at block 122, then method 10 continues and first participant 20-1 is able to participate in competition 15 via the new/unsecure device.

In some embodiments, once participant 20-1 completes competition 15 (or a set portion thereof), participant 20-1 is automatically logged out of gaming platform 30 on the new/unsecure device. In some embodiments, participant 20-1 is automatically logged out of gaming platform 30 on the new/unsecure device after a predetermined amount of time. In some embodiments, the authorization provided by way of participant 20-1 inputting their account information after scanning the barcode allows for only a single wager 110B such that someone who subsequently takes control of the new/unsecure device cannot make further wagers after participant 20-1 leaves the new/unsecure device whether or not participant 20-1 is logged out of gaming platform 30 on the new/unsecure device.

In this way, first participant 20-1 may avoid having to input their cryptocurrency platform 25 account information and gaming platform 30 account information (e.g., username/wallet identification and password) into the new/unsecure device. As the security of this new/unsecure device may be compromised, it may be undesirable to input cryptocurrency platform 25 account information and gaming platform 30 account information (e.g., username/wallet identification and password) into such a device and so this method has the benefit of increasing security for the cryptocurrency platform 25 account and the gaming platform 30 account of first participant 20-1. Further, this may also allow participant 20-1 to avoid a potentially cumbersome process of inputting their cryptocurrency platform 25 account information and/or gaming platform 30 account information into a new/unsecure device which may not have a physical keyboard (e.g., a gaming console with a controller but no keyboard).

At block 120, cryptocurrency platform 25 determines whether to accept authorization request 110A for first participant 20-1. Block 120 may be repeated for each authorization request 110A (e.g., for each subsequent participant 20).

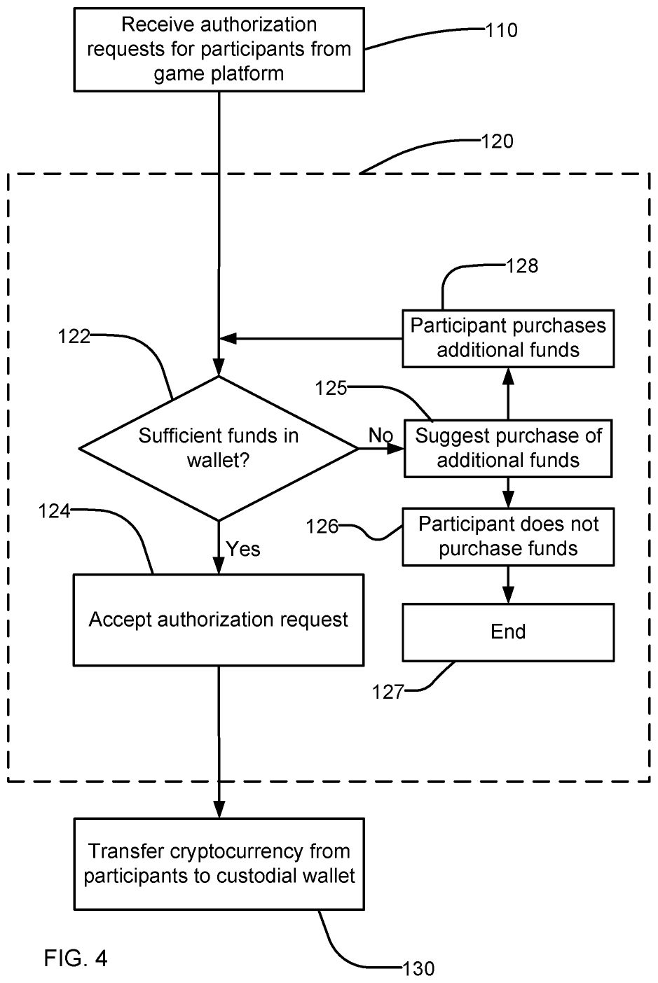

An illustration of an exemplary determination according to block 120 is shown in FIG. 4 as a sub-process of process 10. At block 122, cryptocurrency platform 25 determines whether there are insufficient pre-authorized funds 37A in cryptocurrency wallet 35 of participant 20. The determination at block 122 may be based at least in part on a comparison of the magnitude of wager 110B to the balance of pre-authorized funds 37A in wallet 35 of a first participant 20. Cryptocurrency platform 25 may also confirm at block 122 that the particular game platform 30 is within the scope of authorization provided by participant 20 for pre-authorized funds 37A, whether participant 20 has already wagered more than a pre-specified amount in a particular timeframe and/or ensure that any other limitation of the scope of pre-authorization provided by participant 20 for pre-authorized funds 37A are met by request 110A. If there are not sufficient pre-authorized funds at block 122, request 110A may be denied. In some embodiments, if request 110A is denied for a participant 20, process 10 is ended for that participant 20. Process 10 may continue for other participants 20 despite ending for a particular participant 20.

If there are insufficient funds in cryptocurrency wallet 35 at block 122 (e.g., a “no” determination), participant 20 may be prompted at block 125 with an option to purchase additional cryptocurrency funds 37 to supplement the current balance in first cryptocurrency wallet 35. This option might comprise, for example, displaying a prompt requesting participant 20 to purchase cryptocurrency funds 37 (e.g., in pre-set amounts, in any amount, in the particular amount required to have sufficient funds to satisfy request 110A, etc.) via cryptocurrency platform 25. This prompt might be displayed by game platform 30 and may optionally provide a link or connection to cryptocurrency platform 25 where participant 20 can complete the transaction to obtain further funds 37 and pre-authorize such funds (if needed). If, after block 125, participant 20 purchases additional funds at block 128, then process 10 returns to block 122.

If, at block 125, participant 20 does not purchase or obtain additional funds according to block 126 then request 110A is denied according to block 127. Process 10 may end for that participant 20 at block 127 thereby returning that participant 20 to an appropriate interface of game platform 30.

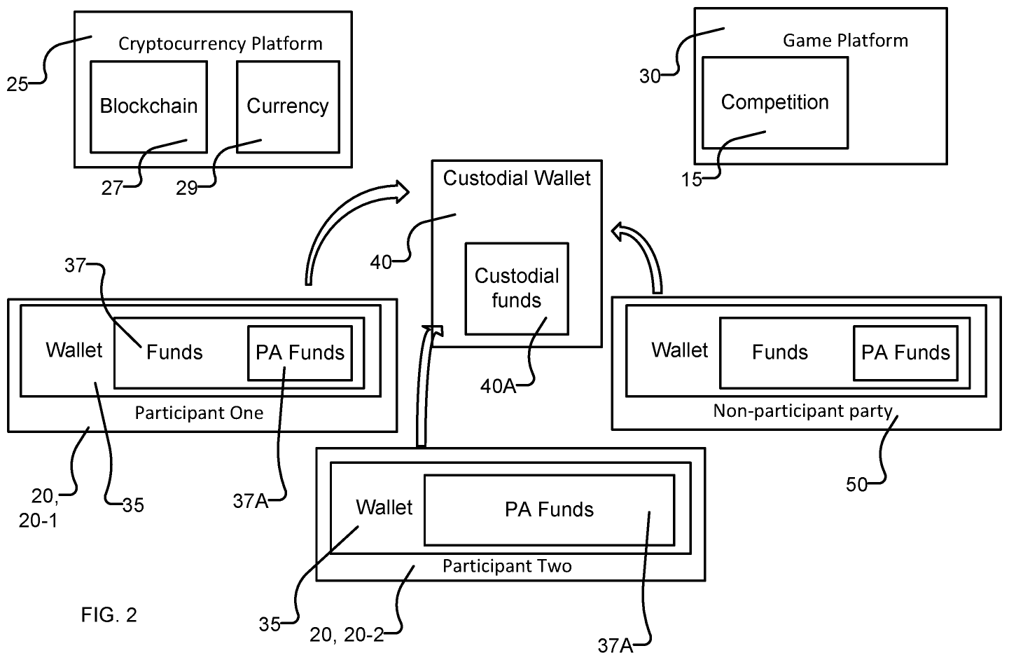

If, at block 122, there are sufficient pre-authorized funds 37A (e.g., a “yes” determination), request 110A is accepted at block 124. Referring again to FIG. 1, if the authorization request 110A is accepted at block 120, process 10 proceeds to block 130 in which wager 110B is transferred from wallet 35 to a custodial wallet 40, as shown, for example, in FIG. 2. Since pre-authorized funds 37A have been pre-authorized by participant 20 for competition fees, wagers etc. such as wager 110B, cryptocurrency platform 25 may transfer wager 110B from wallet 35 to a custodial wallet 40 on behalf of participant 20 without further input or authorization from participant 20. Since participant 20 does not need to provide input or authorization at block 130, process 10 may continue through block 130 without participant 20 needing to leave an ecosystem of game platform 30 thereby creating a seamless wagering experience for participant 20.

Where a wager 110B for one or more participants is zero, method 10 may be substantially the same as where wager 110B is non-zero except that a “yes” determination will automatically occur at block 122 whether or not there are any funds in the wallet of the participant and no cryptocurrency is transferred from the wallet of the participant at block 130.

In some embodiments, custodial wallet 40 may be a common custodial wallet for cryptocurrency platform 25. In some embodiments, custodial wallet 40 may be a common custodial wallet for all online skills-based competitions 15 hosted by game platform 30. In some embodiments, custodial wallet 40 may have other generalized functions as a cryptocurrency wallet for game platform 30. In other embodiments, custodial wallet 40 is a cryptocurrency wallet generated during the initialization of a specific instance of online skills-based competition 15 and associated solely with that specific instance of online skills-based competition 15. In such embodiments, custodial wallet 40 becomes dormant at the conclusion of the specific instance of online-skills based competition 15. Custodial wallet 40 serves as a permanently accessible record on blockchain 27 of the transfers of funds during process 10 (e.g., the transfers of funds from participants 20 at the beginning of the competition 15 and the distribution of funds at the conclusion of the competition 15).

Custodial wallet 40 may contain custodial funds 40A. In some online-skills based competitions 15, custodial funds 40A may comprise, in addition to wagers 110B contributed to custodial wallet 40 by participants 20, further cryptocurrency funds transferred to custodial wallet 40 from one or more other parties. For example, the additional cryptocurrency funds transferred into the custodial wallet 40 may include funds contributed by game platform 30 or funds contributed by a sponsor of the online-skills based competition event 15. In a further example, funds may be contributed to the custodial wallet 40 from a source of funds controlled or operated by the cryptocurrency platform 25, e.g., as part of a general inflationary scheme for the cryptocurrency. Custodial funds 40A in custodial wallet 40 may represent prize money for online skills-based competition 15.

Once custodial funds 40A have been received in custodial wallet 40 from one or more of the participants 20 (and potentially elsewhere), online skills-based competition 15 may proceed. Cryptocurrency platform 25 may send a communication to game platform 30 confirming that custodial funds 40A have been received from a list of participants 20 in competition 15.

From the perspective of game platform 30, when a potential participant 20 attempts to enter a competition 15, game platform 30 checks whether the competition 15 is full. If competition 15 is not full then the online skill-based competition platform sends request 110A to cryptocurrency platform 25 for wager 110B. If the online skills-based competition platform receives confirmation that the event fee has been transferred (e.g., after block 130 occurs), then participant 20 is entered in the competition 15. In the circumstance that this confirmation is not received, an error message may be pushed to participant 20 by game platform 30 and participant 20 may be kicked out of competition 15 (or not allowed to enter). Once a sufficient number of participants 20 have entered competition 15 and/or a pre-determined amount of time has elapsed, then competition 15 may be started. If competition 15 fails to start for some cause (e.g., not enough participants 20 enter competition 15) then competition 15 may be cancelled and a communication may sent to cryptocurrency platform 25 to return wagers 110B from custodial wallet 40A or to not transfer wagers 110B to custodial wallet 40A. If competition 15 starts but does not finish then a similar communication may be sent to cryptocurrency platform 25 to return wagers 110B from custodial wallet 40A.

Online skills-based competition 15 may comprise a short term competitive event, for example spanning a matter of minutes or hours. In some circumstances, online skills-based competition 15 may comprise an extended competitive event, such as a seasonal tournament or an ongoing league (such as a so-called fantasy sports “keeper league”). In such circumstances, fees from participants 20 might be received at the beginning of the tournament and an accumulation of results from individual competitive events during the tournament may determine the outcome of the tournament as a whole.

At block 140, at the conclusion of competition 15, a report 140A is generated by game platform 30 and is delivered to cryptocurrency platform 25. Report 140A may comprise the outcome of online skills-based competition 15. In some circumstances, report 140A may also comprise directions for how custodial funds 40A are to be distributed based on one or more outcomes of competition 15. In other circumstances, the directions for how custodial funds 40A are to be distributed based on one or more outcomes of competition 15 may be pre-determined by one or both of game platform 30 and cryptocurrency platform 25 at some time prior to the conclusion of online skills-based competition 15 such that report 140A merely includes the results of competition 15.

In some circumstances, an interim report 140B from third party 30 may be provided to cryptocurrency platform 25 prior to the completion of competition 15. Interim report 140B may represent interim results of an ongoing online skills-based competition 15 triggering a partial distribution of custodial funds 40A. Interim report 140B may especially be used in the case of a long-term or ongoing competition 15, like a multi-stage event, a league tournament, or other extended or periodic competition that may include interim payouts.

At block 150, cryptocurrency platform 25 may prepare a smart contract 150A. Smart contract 150A may comprise a program storable on blockchain 27 that is configured to execute various actions when certain predetermined conditions are met. For example, smart contract 150A may be configured to distribute custodial funds 40A according to a distribution plan and based at least in part on results of competition 15. For example, first smart contract 150A may be configured to transfer custodial funds 40A between (1) one or more winners of competition 15 from amongst participants 2 (e.g., as set out in report 140A); (2) game platform 30; and/or (3) cryptocurrency platform 25.

In some embodiments, smart contact 150A is generated after cryptocurrency platform 25 receives report 140A (i.e., block 150 occurs after block 140) such that smart contract 150A includes the one or more outcomes of competition 15 at the time it is generated but this is not mandatory. For example, smart contract 150A could be generated prior to block 140 and the execution of smart contract 150A could be conditional upon receipt of report 140A. Smart contract 150A could be generated prior to block 110 such that smart contract 150A could also be conditional upon receipt and determination of requests 110A. In this way, block 150 could occur at various times throughout process 10 (including before process 10) and/or be split in to separate stages during (or before) process 10.

For example, smart contracts 150A could be prepared prior to process 10 for each of a plurality of types of competitions 15 offered by game platform 30 such that each smart contract 150A includes the rules of distribution of custodial funds 140A for a particular type of competition 15 but does not include, for example, identifiers of participants 20, amounts of wagers 110B, outcomes of competition 15, etc. Then, upon or after commencement of process 10, the appropriate smart contract 150A may be chosen (e.g., based on the type of competition 15 for this instance of process 10). At some point after completion of block 120 (but before block 170), the chosen smart contract 150A may retrieve, and/or be updated to include appropriate identification of participants 20 (e.g., wallet IDs and correspondences between such wallet IDs and accounts/identifiers of participants 20 for game platform 30). Further, at some point after completion of block 140, smart contract 150A may retrieve, and/or be updated to include one or more outcomes of competition 15.

At block 160, smart contract 150A is registered on blockchain 27 by cryptocurrency platform 25. Block 160 may occur at any time after the generation of smart contract 150A. For example, in some embodiments, block 160 occurs after block 150 which occurs after block 140 (as shown in FIG. 1) but this is not mandatory. As discussed herein, block 150 may occur at various times during (and even before) process 10 and block 160 may occur at any time after block 150. For example, block 160 may occur after smart contract 150A is generated but before smart contract 150A includes the one or more outcomes of competition 15 (e.g., before block 140). As another example, block 160 may occur after smart contract 150A is generated but before smart contract 150A includes identification details of participants 20 (e.g., before block 110).

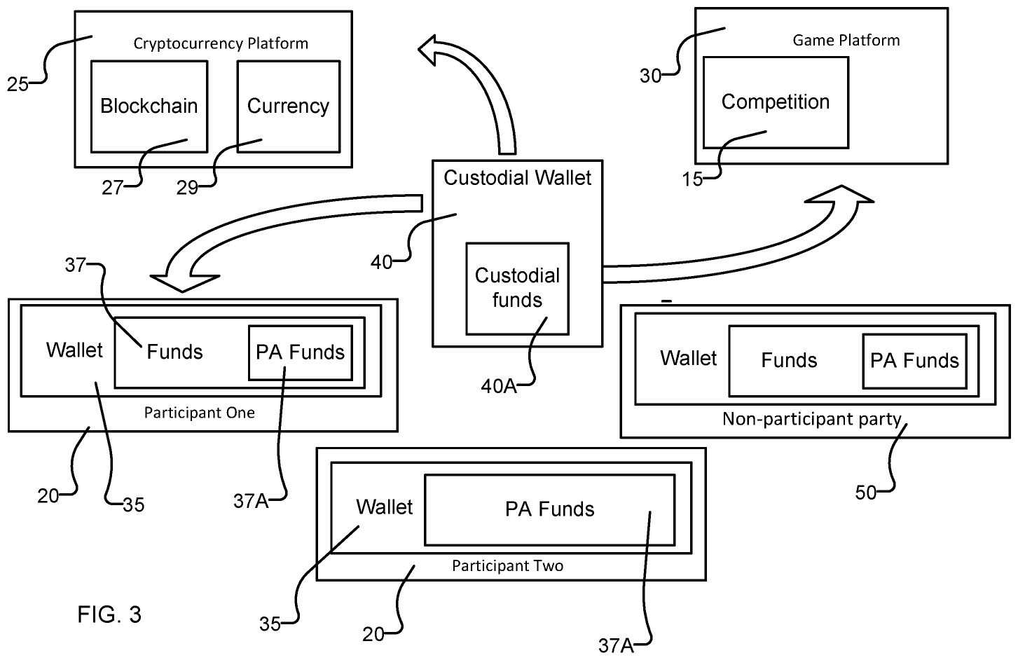

At block 170, cryptocurrency platform 25 causes smart contract 150A to be executed such that custodial funds 40A are distributed as shown, for example, in FIG. 3. The execution of smart contract 150A may be initiated by cryptocurrency platform 25 by sending a communication to the nodes on blockchain 27. The various nodes of blockchain 27 then execute the code embedded in smart contract 150A in parallel. The consequences of the execution code embedded in smart contract 150A are registered by the various nodes of blockchain 27, completing the transaction.

If the conditions for its execution have been met, then smart contract 150A may be executed immediately. Execution of first smart contract 150A may occur concurrently with the registration of smart contract 150A on blockchain 27 as a single step. If the conditions for the execution of smart contract 150A have not been met, then it may be registered (picked up by nodes and recorded on blockchain 27), but remain unexecuted until the remaining conditions have been satisfied.

Where block 160 occurs prior to the completion of smart contract 150A (e.g., prior to block 140 and/or prior to block 110 or 120), smart contract 150A may be updated in any suitable manner. For example, updating smart contract 150A with such information may comprise the use of a blockchain oracle, by registering the information of report 140A on blockchain 27 in a manner accessible by the nodes executing smart contract 150A or by other mechanisms for accessing identification information of participants 20 and/or the one or more outcomes of competition 15. The blockchain oracle would determine which participants 20 won competition 15 (and/or scored points, achieved a specific outcome, etc.) by accessing report 140A received by cryptocurrency platform 25. In this scenario, the execution instructions sent by cryptocurrency platform 25 to the nodes on the distributed ledger cause the nodes on the distributed ledger to execute the code in the smart contract 150A, which includes a blockchain oracle. The blockchain oracle executed by each node may submit a request to cryptocurrency platform 25 for the information contained in report 140A. Alternatively, the blockchain oracle may request the information directly from the game platform 30, or from some other source where report 140A (or the information therein) might be made available. If the nodes of blockchain 27 agree on the information received after the execution of the blockchain oracle, then the code in the smart contract 150A triggers the distribution of custodial funds 40A at block 170 based on the clauses of smart contract 150A.

Distribution of custodial funds 40A at block 170 may comprise distributing at least a portion of custodial funds 40A to winners (e.g., top 3, top 5, top 10, etc.) of competition 15. Distribution of custodial funds 40A at block 170 may comprise distributing at least a portion of custodial funds 40A to participants 20 that achieved a particular outcome (e.g., other than winning or placing in the top 3, 5, 10, etc.) such as, for example, a participant with the fastest lap in a racing competition, a participant with the most points in a sports competition, etc. Distribution of custodial funds 40A at block 170 may comprise distributing at least a portion of custodial funds 40A to game platform 30 (e.g., as an entry fee or as a cut of wagers 110B). Distribution of custodial funds 40A at block 170 may comprise distributing at least a portion of custodial funds 40A to game platform 30 (e.g., as a service fee).

At the end of process 10, custodial wallet 40 and/or smart contract 150A may serve as an immutable record of competition 15 such that participants 20 (and non-participants) can later view the one or more outcomes of competition 15 and the distribution of custodial funds 40A.

By at least the foregoing, process 10 allows game platform 30 to implement cryptocurrency wagering with minor investment of resources. For example, game platform 30 is configured to merely sends requests 110A and reports 140A while cryptocurrency platform 25 processes all cryptocurrency transactions, smart contract generation, etc.

In some embodiments, if competition 15 does not conclude within a pre-determined timeframe, then this may trigger an error function. This error function may be run in software controlled by cryptocurrency platform 25 or may be embedded in smart contract 150A. In the case that the error function is run in software controlled by cryptocurrency platform 25, the execution of the error function may cause the initiation of a transaction registered on the blockchain causing the distribution (e.g., refunding) of custodial funds 40A back to participants 20 (and any other sources that contributed).

For example, the error function may be triggered once a specified period of time has passed without receiving report 140A from game platform 30 indicating the conclusion of online skills-based competition 15. The error function may then cause the automatic distribution of custodial funds 40A back to participants 20.

In some embodiments, process 10 may incorporate one or more additional smart contracts to execute transactions within process 10. The transfer of wagers 110B from wallets 35 of participants 20 to custodial wallet 40 at block 130 may be executed by the registration and execution of a single smart contract, or by individual smart contracts registered and executed for each participant 20.

The transfer of wagers 110B from wallets 35 of participants 20 to custodial wallet 40 at block 130 may be incorporated into smart contract 150A where smart contract 150A is prepared and registered prior to block 130. For example, smart contract 150A may comprise a multi-stage smart contract wherein at the first stage, wagers 110B are transferred from wallets 35 of participants 20 to custodial wallet 40 at block 130 and at a second stage, custodial funds 40A are distributed based at least in part on report 140A (as discussed further herein). The execution of the first stage of the multi-stage smart contract may be triggered, for example, by a communication (e.g., an API call) from game platform 30 that competition 15 is full, or that no more requests 110A will be coming, all participants are prepared for the start of the competition (e.g., are waiting in a game lobby), based on an elapsed period of time since a first request 110A, etc. After the execution of the first stage of the multi-stage smart contract, cryptocurrency platform 25 may communicate to game platform 30 confirming that wagers 110B have been transferred from each participant 20 to custodial wallet 40A. Game platform 30 may then begin competition 15. The execution of the second stage of smart contract 150A (e.g., at block 170) may be triggered by receipt of report 140A or otherwise.

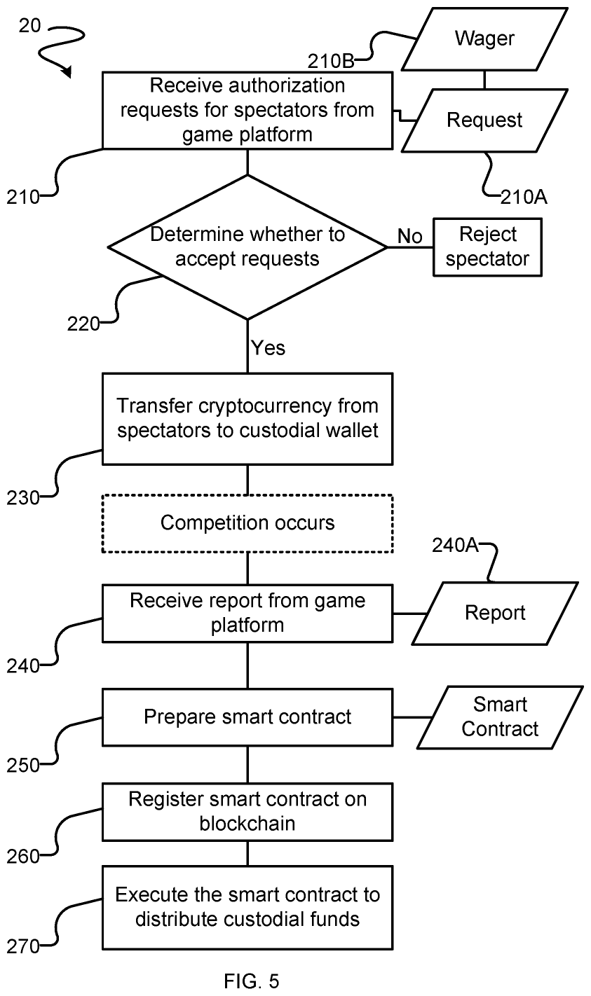

Process 10 may also, with minor variation, be suitable for wagering on competition 15 by non-participating parties 50. In other words, non-participating parties 50 (also referred to herein as spectators 50) could wager on one or more outcomes of competition 15. For example, FIG. 5 represents a process 20 in which facilitates game platform 30 in permitting the wagering of cryptocurrency 29 on one or more outcomes of competition 15 by spectators 50. Process 20 may facilitate game platform 30 to utilize cryptocurrency 29 for wagering on competition 15 without requiring game platform 30 to invest significant resources in integrating cryptocurrency wagering.

Process 20 may be substantially similar to process 10 except as follows. For example, process 20 may comprises blocks 210, 220, 230, 240, 250, 260 and 270 substantially similar to blocks 110, 120, 130, 140, 150, 160 and 170 of process 10, respectively. However, unlike process 10, requests 210A for wagers 210B may be received by cryptocurrency platform 25 on behalf of spectators 50 rather than (or in addition to) participants 20. Like participants 20, spectators 50 may have one or more wallets 35 holding pre-authorized funds 37A.

Much like block 140, a report 240A is received by cryptocurrency platform 25 at block 240. Report 240A may comprise the results of competition 15. Report 240A may comprise further details of wagers 210B such as, for example, the specifics of each wager (e.g., who each spectator 50 chose to win, who each spectator 50 chose to achieve a particular outcome within competition 15, a total number of points scored in competition 15, a spread between points of participants 20, etc.). Report 240A may comprise the rules of distribution of custodial funds 40A of process 20 or such rules of distribution may have been otherwise communicated to cryptocurrency platform 25 (e.g., as part of request 210A), prior to process 20 or as otherwise described elsewhere herein with respect to process 10. In some embodiments, process 20 utilizes the same custodial wallet 40 as process 10 although this is not mandatory and process 20 could employ a separate custodial wallet 40 from process 10.

Game platform 30 may employ a video game digital distribution service for personal computers, gaming devices, mobile phones, or the like such as, for example, Steam™, UPlay™, Epic Games™, Xbox™, Playstation™, the Apple™ App Store™, Google Play™, and/or GOG.com™. Participants may have accounts with at least one of the video game digital distribution services distributing the online skills-based competition 15.

### Example Scenario 1

In a first non-limiting example scenario, online skills-based competition 15 is a team-based video game competition between two teams where each team comprises five participants 20. In example scenario 1, cryptocurrency platform 25 assists game platform 30 in enabling participants 20 to wager cryptocurrency 29 on the outcome of competition 15 according to process 10 illustrated in FIG. 1. Each participant 20 attempts to join competition 15 through a menu interface of game platform 30. Each participant 20 may see a confirmation screen asking participant 20 if they want to bet wager 110B. If, for example, a first participant 20-1 agrees at the confirmation screen, this causes game platform 30 to send a request 110A, for example via API call, to cryptocurrency platform 25 on behalf of first participant 20-1 which is received according to block 110 of process 10. Cryptocurrency platform 25 determines whether to accept request 110A of first participant 20-1 according to block 120. If cryptocurrency platform 25 accepts request 110A of participant 20-1, pre-authorized cryptocurrency funds 37A representing the wager 110B of participant 20-1 are transferred from the wallet 35 of participant 20-1 to custodial wallet 40 generated by cryptocurrency platform 25, according to block 130. These preceding steps are conducted for each of the ten participants 20 in the video game team competition 15.

Game platform 30 then runs competition 15. At the completion of competition 15, game platform 30 generates a report 140A indicating which team won. Report 140A is delivered to cryptocurrency platform 25, at block 140, through an appropriate communication, such as an API call. Report 140A may include information including which participants 20 were on each team and which team won competition 15. When cryptocurrency platform 25 receives report 140A (e.g., by API call) from game platform 30, cryptocurrency platform 25 generates a smart contract 150A (if not already generated earlier in process 10 or prior to process 10) based at least in part on the contents of report 140A according to block 150. The generation of the smart contract 150A may include code instructions for distributing custodial funds 40A from custodial wallet 40 to participants 20 on the winning team (e.g., according to payout rules specified by game platform 30 in report 140A or otherwise). The instructions included in the smart contract 150A may also include directions to distribute a portion of custodial funds 40A between one or more wallets associated with one or both of the game platform 30 and cryptocurrency platform 25. Cryptocurrency platform 25 then registers the smart contract 150A on the blockchain 27 according to block 160 and executes that smart contract 150A according to block 170. The execution of the smart contract 150A executes the instructions to distribute custodial funds 40A between participants 20 on the winning team. In some embodiments (e.g., where there are more than two teams), funds may be distributed to a plurality of teams, such as, the top two or three teams in competition 15.

In some variations on this example, report 140A may include statistics about the game, including a point system differentiating the performances of various individual participants 20 in competition 15. In such a variation, execution of smart contract 150A may distribute at least a portion of custodial funds 40A between participants 20 (from amongst the winning team or otherwise) with higher point scores.

### Example Scenario 2

In a second non-limiting example according to process 10, online skills-based competition 15 is a racing video game in which each participant 20 races against other participants 20. In example scenario 2, cryptocurrency platform 25 assists game platform 30 in enabling participants 20 to wager cryptocurrency 29 on one or more outcomes of competition 15 according to process 10 illustrated in FIG. 1. Each participant 20 attempts to join competition 15 through a menu interface of game platform 30. Each participant 20 may see a confirmation screen asking participant 20 if they want to bet wager 110B. If, for example, a first participant 20-1 agrees at the confirmation screen, this causes game platform 30 to send a request 110A, for example via API call, to cryptocurrency platform 25 on behalf of first participant 20-1 which is received according to block 110 of process 10. Cryptocurrency platform 25 determines whether to accept request 110A of first participant 20-1 according to block 120. If cryptocurrency platform 25 accepts request 110A of participant 20-1, pre-authorized cryptocurrency funds 37A representing the wager 110B of participant 20-1 are transferred from the wallet 35 of participant 20-1 to custodial wallet 40 generated by cryptocurrency platform 25, according to block 130. These preceding steps are conducted for each participant 20 in the video game race.

Prior to receiving report 140A from game platform 30, cryptocurrency platform 25 generates a smart contract 150A based on a pre-determined distribution arrangement for custodial funds 40A according to future outcomes of competition 15 according to block 150. The generation of the smart contract 150A includes code instructions for distributing custodial funds 40A based at least in part on the order in which participants 20 finish the race of competition 15. For example, smart contract 150A might instruct that the first-place participant 20 will receive 50% of custodial funds 40A, the second-place participant 20 will receive 30% of custodial funds 40A, and the third-place participant 20 will receive 15% of custodial funds 40A while the remaining 5% of the custodial funds 40A is to be distributed in equal parts between a cryptocurrency wallet associated with cryptocurrency platform 25 and a cryptocurrency wallet associated with the game platform 30. Cryptocurrency platform 25 may register this first smart contract on the blockchain in accordance with block 160 prior to receiving report 140A.

After the completion of competition 15, game platform 30 generates report 140A indicating the placement of each participant 20 in the race of competition 15. Report 140A is received by cryptocurrency platform 25, at block 140, through an appropriate communication, such as an API call. When cryptocurrency platform 25 receives report 140A, it provides the necessary information of report 140A to smart contract 150A thereby allowing smart contract 150A to be executed at block 170 such that custodial funds 40A are distributed to at least one participant 20, game platform 25 and cryptocurrency platform 30.

### Example Scenario 3

In a third non-limiting example scenario, competition 15 comprises a multi-season competition 15 with payouts for participants with the most points accumulated in each season as well as payouts for the participant 20 with the most points accumulated across all seasons at the conclusion of competition 15. In example scenario 3, blocks 140, 150, 160 and 170 may be repeated at the conclusion of each season of competition 15 such that a new smart contract 150A is prepared, registered and executed for each season of competition 15. At the conclusion of each season of competition 15 (aside from the last season), less than all of custodial funds 40A may be distributed thereby leaving some for the remaining seasons of competition 15. At the conclusion of competition 15, all remaining custodial funds 40A are distributed. In some embodiments, participants are required to provide further wagers 110B according to blocks 110 to 130 at various times throughout competition 15 to be allowed to continue as part of competition 15 but this is not mandatory.

Alternatively, in example scenario 3, blocks 150 and 160 may only occur a single time and smart contract 150A may comprise a multi-stage smart contract wherein a stage of smart contract 150A is executed at the end of each season of competition 15 based on a report 140A for that season.

### ASPECTS

1. A method for facilitating wagering of cryptocurrency registered on a blockchain or distributed ledger between participants in an online skills-based competition hosted by a third party, each participant having a cryptocurrency wallet registered on the blockchain or distributed ledger, the method comprising:
   for each participant:
      receiving an authorization request from the third party for a wager of the cryptocurrency;
      determining if the authorization request should be accepted based at least in part on a balance in the cryptocurrency wallet of the participant and, if accepted, transferring a first quantity of cryptocurrency from the cryptocurrency wallet of the cryptocurrency holder to a custodial wallet based at least in part on the wager;
   receiving from the third party a report of one or more measurable outcomes from the online skill-based competition;
   preparing a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition;
   registering the smart contract on the blockchain ledger; and
   executing the smart contract to thereby distribute the at least a portion of cryptocurrency in the custodial wallet to the respective cryptocurrency wallets of the one or more of the participants based at least in part on the report of the one or more measurable outcomes.
2. The method of aspect 1 or any other aspect herein wherein the first smart contract is produced dynamically based in part on the report of the one or more measurable outcomes from the online skills-based competition.
3. The method of any one of aspects 1 and 2 or any other aspect herein wherein the balance in the cryptocurrency wallet of the participant is a balance of pre-authorized cryptocurrency in the wallet of the participant.
4. The method of aspect 3 or any other aspect herein wherein the pre-authorized cryptocurrency is pre-authorized by the participant for use in wagering or competition fees for the online skills-based competition hosted by the third party.
5. The method of any one of aspects 3 and 4 or any other aspect herein wherein the pre-authorized cryptocurrency represents only a portion of a total balance in the cryptocurrency wallet of the participant.
6. The method of any one of aspects 3 to 5 or any other aspect herein wherein transferring the first quantity of cryptocurrency from the cryptocurrency wallet of the cryptocurrency holder to the custodial wallet based at least in part on the wager is carried out on behalf of the participant since the pre-authorized cryptocurrency is pre-authorized by the participant for use in wagering or competition fees for the online skills-based competition hosted by the third party.
7. The method of any one of aspects 1 to 6 or any other aspect herein wherein preparing the smart contract occurs prior to transferring the first quantity of cryptocurrency from the cryptocurrency wallet of the cryptocurrency holder to the custodial wallet based at least in part on the wager and transferring the first quantity of cryptocurrency from the cryptocurrency wallet of the cryptocurrency holder to the custodial wallet based at least in part on the wager comprises executing a first stage of the smart contract.
8. The method of any one of aspects 1 to 7 or any other aspect herein wherein preparing the smart contract occurs prior to receiving the authorization request from the third party for the wager of the cryptocurrency for each participant.
9. The method of any one of aspects 1 to 8 or any other aspect herein comprising returning the first quantity of cryptocurrency to the cryptocurrency wallets of the participants in the event of a parameter failure or the non-receipt of the report of the one or more measurable outcomes within a pre-defined period of time.
10. The method of aspect 9 or any other aspect herein comprising executing a fault-response smart contract, the fault-response smart contract performing the returning of the first quantity of cryptocurrency to the cryptocurrency wallets of the participants in the event of a parameter failure or the non-receipt of the report of the one or more measurable outcomes within a pre-defined period of time.
11. The method of aspect 9 or any other aspect herein wherein returning the first quantity of cryptocurrency to the cryptocurrency wallets of the participants is performed by the first smart contract.
12. The method any one of aspects 1 to 11 or any other aspect herein wherein the first quantity of cryptocurrency comprises entry fees and the one or more measurable outcomes comprises a scoring list for a set of players in the online skills-based competition.
13. The method of any one of aspects 1 to 12 or any other aspect herein wherein one or more of the cryptocurrency holders are players in the online skills-based competition.
14. The method of any one of aspects 1 to 13 or any other aspect herein wherein one or more participants are spectators of the online skills-based competition.
15. The method of any one of aspects 1 to 14 or any other aspect herein wherein for a first participant of the participants, the authorization request from the third party for the wager of the cryptocurrency is received in response to the first participant scanning, with a mobile device of the first participant, a barcode displayed by the third party on a first display and inputting account information into a form displayed on the mobile device in response to scanning the barcode.
16. The method of aspect 15 or any other aspect herein wherein the barcode is a QR code.
17. The method of any one of aspects 15 and 16 or any other aspect herein wherein the account information comprises account information for the third party.
18. The method of any one of aspects 15 and 16 or any other aspect herein wherein the account information comprises account information for the cryptocurrency wallet of the participant.
19. The method of any one of aspects 1 to 18 or any other aspect herein wherein the wager is the same for each participant.
20. The method of any one of aspects 1 to 18 or any other aspect herein wherein the wager for each participant is based on a skill level, ranking and/or handicap of each participant.
21. A method of distributing cryptocurrency between spectators of a video game event, the method comprising:
   transferring a first quantity of cryptocurrency from the first cryptocurrency wallet of each of a plurality of cryptocurrency holders participating in the video game event to a custodial wallet;
   receiving a report of one or more measurable outcomes from the video game event; and
   deploying a first smart contract to distribute a portion of cryptocurrency in the custodial wallet to one or more of the cryptocurrency holders, wherein the distribution of the portion of cryptocurrency is based in part on the report of the one or more measurable outcomes from the video game event.
22. The method according to aspect 21 or any other aspect herein comprising any of the features and/or steps of any one of aspects 1 to 20 or any other aspect herein.
23. A method of distributing cryptocurrency between cryptocurrency holders involved in a video game event, each cryptocurrency holder having a first cryptocurrency wallet, the method comprising:
   transferring a first quantity of cryptocurrency from the first cryptocurrency wallet of each cryptocurrency holder participating in the video game event to a custodial wallet;
   receiving a report of one or more measurable outcomes from the video game event; and
   distributing a portion of the first quantity of cryptocurrency in the custodial wallet to one or more of the cryptocurrency holders based on the report of the one or more measurable outcomes from the video game event.
24. The method according to aspect 23 or any other aspect herein comprising any of the features and/or steps of any one of aspects 1 to 20 or any other aspect herein.
25. A method of distributing cryptocurrency registered on a first blockchain ledger between cryptocurrency holders, each cryptocurrency holder involved in an online skill-based competition hosted by a third party, each cryptocurrency holder having a first cryptocurrency wallet registered on the first blockchain ledger, the method comprising:
   for each cryptocurrency holder:
      receiving a authorization request from the third party for a wager of a first quantity of cryptocurrency;
      determining if the authorization request should be accepted based at least in part on a balance in the first cryptocurrency wallet of the cryptocurrency holder and, if accepted, transferring a first quantity of cryptocurrency from the first cryptocurrency wallet of the cryptocurrency holder to a custodial wallet;
   receiving from the third party a report of one or more measurable outcomes from the online skill-based competition;
   preparing a first smart contract to distribute a portion of cryptocurrency in the custodial wallet to one or more of the cryptocurrency holders, wherein the distribution of the portion of cryptocurrency is based at least in part on the report of the one or more measurable outcomes from the online skill-based competition;
   registering the first smart contract on the first blockchain ledger; and
   executing the first smart contract to thereby distribute a portion of cryptocurrency in the custodial wallet to the respective first cryptocurrency wallets of the one or more of the cryptocurrency holders based at least in part on the report of the one or more measurable outcomes.
26. The method according to aspect 25 or any other aspect herein comprising any of the features and/or steps of any one of aspects 1 to 20 or any other aspect herein.
27. A method of distributing cryptocurrency registered on a first blockchain ledger between cryptocurrency holders, each cryptocurrency holder involved in an online skill-based competition hosted by a third party, each cryptocurrency holder having a first cryptocurrency wallet registered on the first blockchain ledger, the method comprising:
   registering a first smart contract on the first blockchain ledger;
   executing a first stage of the first smart contract to transferring a first quantity of cryptocurrency from the first cryptocurrency wallet of each cryptocurrency holder participating in the online skill-based competition to a custodial wallet;
   executing a second stage of the first smart contract to distribute a first portion of the first quantity of cryptocurrency in the custodial wallet to one or more of the cryptocurrency holders based on one or more measurable outcomes from the online skills-based competition.
28. The method according to aspect 27 or any other aspect herein comprising any of the features and/or steps of any one of aspects 1 to 20 or any other aspect herein.
29. A system comprising at least one server and/or processor having at least one application program and computer instructions operating thereon which are configured to cause at least one server and/or processor to perform the methods, steps and/or functions according to any one of aspects 1 to 28.
30. A non-transitory, computer readable medium having at least one application program or computer instructions operating thereon which are configured to cause at least one server and/or processor to perform the methods, steps and/or functions according to any one of aspects 1 to 28.
31. A system for facilitating wagering of cryptocurrency registered on a blockchain or distributed ledger between participants in an online skills-based competition hosted by a third party, each participant having a cryptocurrency wallet registered on the blockchain or distributed ledger, the system configured to, for each participant:
   receive an authorization request from the third party for a wager of the cryptocurrency;
   determine if the authorization request should be accepted based at least in part on a balance in the cryptocurrency wallet of the participant and, if accepted, transfer a first quantity of cryptocurrency from the cryptocurrency wallet of the cryptocurrency holder to a custodial wallet based at least in part on the wager;
receive from the third party a report of one or more measurable outcomes from the online skill-based competition;
prepare a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition;
register the smart contract on the blockchain ledger; and
execute the smart contract to thereby distribute the at least a portion of cryptocurrency in the custodial wallet to the respective cryptocurrency wallets of the one or more of the participants based at least in part on the report of the one or more measurable outcomes.
32. The system according to aspect 31 or any other aspect herein comprising any of the features and/or steps of any one of aspects 1 to 28 or any other aspect herein.
33. Methods comprising any features, combinations of features and/or sub-combinations of features described herein or inferable therefrom.
34. Apparatus comprising any features, combinations of features and/or sub-combinations of features described herein or inferable therefrom.
35. Kits comprising any features, combinations of features and/or sub-combinations of features described herein or inferable therefrom.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component (e.g., a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

In some embodiments, a non-transitory, computer readable medium is provided having one or more of an application program including computer instructions configured to cause at least one server and/or at least one processor to perform the methods (or one or more steps/blocks thereof) according to any of the disclosed methods.

Method embodiments (as well as one or more steps thereof) can be configured as computer readable program instructions (corresponding to the blocks/steps/methods) and can be downloaded to respective computing/processing devices from a computer readable storage medium or to an external computer or external storage device via a network, for example, the Internet, a local area network, a wide area network and/or a wireless network.

Aspects of the present disclosure are described sometimes with reference to a flow, a flow diagram, and/or block diagram of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions, operable, for example, on one or more components (e.g., server(s), processor(s)). These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks, in accordance with embodiments of the present disclosure.

Any flowchart and block diagrams of the present disclosure are examples of architecture, functionality, and operations, of at least some of the embodiments of systems, methods, and computer readable media supported herein. In this regard, each block in the flowchart or block diagrams may represent a module, segment, or portion of instructions, which includes one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be understood that at least some embodiments of the present disclosure can correspond to a cloud computing environment, but are not so limited, as embodiments of the present disclosure are capable of being implemented in conjunction with any other type of computing environment now known or later developed. With respect to a cloud computing environment, such is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for facilitating wagering of cryptocurrency registered on a blockchain or distributed ledger between participants in an online skills-based competition hosted by a third party, each participant having a cryptocurrency wallet registered on the blockchain or distributed ledger, the method comprising:
for each participant:
receiving an authorization request from the third party for a wager of the cryptocurrency;
determining if the authorization request should be accepted based at least in part on a balance in the cryptocurrency wallet of the participant and, if accepted, transferring a first quantity of cryptocurrency from the cryptocurrency wallet of the cryptocurrency holder to a custodial wallet based at least in part on the wager;
receiving from the third party a report of one or more measurable outcomes from the online skill-based competition;
preparing a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition;
registering the smart contract on the blockchain ledger; and
executing the smart contract to thereby distribute the at least a portion of cryptocurrency in the custodial wallet to the respective cryptocurrency wallets of the one or more of the participants based at least in part on the report of the one or more measurable outcomes.

2. The method of claim 1 wherein the first smart contract is produced dynamically based in part on the report of the one or more measurable outcomes from the online skills-based competition.

3. The method of claim 1 wherein the balance in the cryptocurrency wallet of the participant is a balance of pre-authorized cryptocurrency in the wallet of the participant.

4. The method of claim 3 wherein the pre-authorized cryptocurrency is pre-authorized by the participant for use in wagering or competition fees for the online skills-based competition hosted by the third party.

5. The method of claim 3 wherein the pre-authorized cryptocurrency represents only a portion of a total balance in the cryptocurrency wallet of the participant.

6. The method of claim 3 wherein transferring the first quantity of cryptocurrency from the cryptocurrency wallet of the cryptocurrency holder to the custodial wallet based at least in part on the wager is carried out on behalf of the participant since the pre-authorized cryptocurrency is pre-authorized by the participant for use in wagering or competition fees for the online skills-based competition hosted by the third party.

7. The method of claim 1 wherein preparing the smart contract occurs prior to transferring the first quantity of cryptocurrency from the cryptocurrency wallet of the cryptocurrency holder to the custodial wallet based at least in part on the wager and transferring the first quantity of cryptocurrency from the cryptocurrency wallet of the cryptocurrency holder to the custodial wallet based at least in part on the wager comprises executing a first stage of the smart contract.

8. The method of claim 1 wherein preparing the smart contract occurs prior to receiving the authorization request from the third party for the wager of the cryptocurrency for each participant.

9. The method of claim 1 wherein the first quantity of cryptocurrency comprises entry fees and the one or more measurable outcomes comprises a scoring list for a set of players in the online skills-based competition.

10. The method of claim 1 wherein one or more of the cryptocurrency holders are players in the online skills-based competition.

11. The method of claim 1 wherein one or more participants are spectators of the online skills-based competition.

12. The method of claim 1 wherein for a first participant of the participants, the authorization request from the third party for the wager of the cryptocurrency is received in response to the first participant scanning, with a mobile device of the first participant, a barcode displayed by the third party on a first display and inputting account information into a form displayed on the mobile device in response to scanning the barcode.

13. The method of claim 12 wherein the barcode is a QR code.

14. The method of claim 12 wherein the account information comprises account information for the third party.

15. The method of claim 12 wherein the account information comprises account information for the cryptocurrency wallet of the participant.

16. The method of claim 1 wherein the wager is the same for each participant.

17. The method of claim 1 wherein the wager for each participant is based on a skill level, ranking and/or handicap of each participant.

18. A method of distributing cryptocurrency registered on a first blockchain ledger between cryptocurrency holders, each cryptocurrency holder involved in an online skill-based competition hosted by a third party, each cryptocurrency holder having a first cryptocurrency wallet registered on the first blockchain ledger, the method comprising:
for each cryptocurrency holder:
receiving a authorization request from the third party for a wager of a first quantity of cryptocurrency;
determining if the authorization request should be accepted based at least in part on a balance in the first cryptocurrency wallet of the cryptocurrency holder and, if accepted, transferring a first quantity of cryptocurrency from the first cryptocurrency wallet of the cryptocurrency holder to a custodial wallet;
receiving from the third party a report of one or more measurable outcomes from the online skill-based competition;
preparing a first smart contract to distribute a portion of cryptocurrency in the custodial wallet to one or more of the cryptocurrency holders, wherein the distribution of the portion of cryptocurrency is based at least in part on the report of the one or more measurable outcomes from the online skill-based competition;
registering the first smart contract on the first blockchain ledger; and
executing the first smart contract to thereby distribute a portion of cryptocurrency in the custodial wallet to the respective first cryptocurrency wallets of the one or more of the cryptocurrency holders based at least in part on the report of the one or more measurable outcomes.

19. A non-transitory, computer readable medium having at least one application program or computer instructions operating thereon which are configured to cause at least one server and/or processor to perform the methods, steps and/or functions according to claim 1.

20. A system for facilitating wagering of cryptocurrency registered on a blockchain or distributed ledger between participants in an online skills-based competition hosted by a third party, each participant having a cryptocurrency wallet registered on the blockchain or distributed ledger, the system configured to, for each participant:
receive an authorization request from the third party for a wager of the cryptocurrency;
determine if the authorization request should be accepted based at least in part on a balance in the cryptocurrency wallet of the participant and, if accepted, transfer a first quantity of cryptocurrency from the cryptocurrency wallet of the cryptocurrency holder to a custodial wallet based at least in part on the wager;
receive from the third party a report of one or more measurable outcomes from the online skill-based competition;
prepare a smart contract to distribute at least a portion of cryptocurrency in the custodial wallet to one or more of the participants, wherein the distribution of the at least a portion of cryptocurrency is based at least in part on the report of the one or more measurable outcomes from the online skill-based competition;
register the smart contract on the blockchain ledger; and
execute the smart contract to thereby distribute the at least a portion of cryptocurrency in the custodial wallet to the respective cryptocurrency wallets of the one or more of the participants based at least in part on the report of the one or more measurable outcomes.
